(19) United States
(12) Patent Application Publication
(10) Pub. No.: US 2023/0226510 A1
(43) Pub. Date: Jul. 20, 2023

(54) METHOD AND SYSTEM FOR PREVENTING CARBON DEPOSITION IN FLUIDIZED BED REACTOR FOR SYNTHESIS OF ORGANOSILICON MONOMER

(71) Applicant: Qingdao University of Science & Technology, Qingdao (CN)

(72) Inventors: Pan ZHANG, Qingdao (CN); Guanghui CHEN, Qingdao (CN); Weiwen WANG, Qingdao (CN); Jianlong LI, Qingdao (CN)

(21) Appl. No.: 18/189,236

(22) Filed: Mar. 24, 2023

(51) Int. Cl. B01J 8/18; C07F 7/16

(52) U.S. Cl. CPC B01J 8/1836; B01J 8/1827; C07F 7/16; B01J 2208/00938; B01J 2208/00132

(57) ABSTRACT

Disclosed are a method and device for preventing carbon deposition in a fluidized bed reactor for the organosilicon monomer synthesis. The device includes a tank, at least one U-shaped heat exchange tube, and at least one upper flow-guide block. The U-shaped heat exchange tube includes an elbow portion, and is arranged vertically with the elbow portion at a lower end. The upper flow-guide block is arranged on an upper surface of the elbow portion. A width of the upper flow-guide block decreases from an end connected to the elbow portion to an end away from the elbow portion.

### TECHNICAL FIELD

This application relates to chemical engineering devices, and more particularly to a method and system for preventing carbon deposition in a fluidized bed reactor for the synthesis of organosilicon monomer.

### BACKGROUND

Silicone materials are a class of polymers that contain Si—C bonds and organic groups directly linked to Si atoms. Due to the presence of the organic groups and inorganic structure, they have excellent characteristics, such as high/low temperature resistance, electrical insulation, oxidation resistance, weather resistance, flame retardancy, hydrophobicity, corrosion resistance, non-toxicity and odorless, and physiological inertness. Hence, silicone has been widely used in aerospace, electronics, automotive, and medical and health fields. The synthesis of silicone monomers is the basis of the development of silicone materials and industry. In particular, dimethyldichlorosilane (M2), accounting for more than 90% of the total monomer yield, is mainly prepared from silica powder and chloromethane gas via a one-step reaction in a fluidized bed reactor under the catalysis of a Cu-based catalyst. This synthesis system is a multi-phase catalytic reaction accompanied by multiple side reactions. By means of the internal heat exchange component, the heat generated from the exothermic reaction is discharged in time to achieve a constant reaction temperature, which is beneficial to improving the selectivity of M2. The existing internal heat exchange component mainly includes a finger-shaped tube and a U-shaped heat exchange tube. Regarding the U-shaped heat exchange tube, due to geometric changes in the cross-section of the connection between cylinder and cone, the elbow of the U-shaped heat exchanger tube, and uneven gas distribution, the fluidized bed reactor will suffer deterioration of the gas-solid fluidization at the bottom, which results in the occurrence of flow dead zones and local overheating, causing carbon deposition and poor M2 selectivity, and even causing blockage and stoppage of the fluidized bed reactor. This phenomenon seriously affects the production capacity and efficiency, and leads to excessive material and energy consumption.

Chinese Patent Application No. 202010438987.0 discloses a gas distributor for a fluidized bed reactor applied to the silicone synthesis, which includes a central zone and a sidewall zone. A particle guide device is provided on the periphery of the sidewall zone for drawing particles deposited in the sidewall zone and ejecting them in a horizontal direction or an approximately horizontal direction to the area above the central zone thus eliminating the accumulation dead zones in the sidewall zone. However, the particle guide device will inevitably hinder the airflow and particles, which is not conducive to the movement of the particles in a fluidization state. Moreover, the particles above the gas distributor move at a high speed and thus have a significant erosion effect on the particle guide device, which greatly reduces the reliability of the particle guide device.

Chinese Patent Applications No. 201320397963.0, No. 201320431357.6 and No. 201610350683.2 disclose the arrangement of a certain number of gas injection tubes on a reactor cylinder. The gas injection tubes are connected to the gas main tube surrounding the reactor cylinder, and each gas injection tube forms a certain angle with the tangent line of the connection point between the gas injection tube and the reactor cylinder. Similar to the Chinese Patent Application No. 202010438987.0, the gas injection tubes will inevitably pose obstructive effect on the movement of airflow and particles, leading to deterioration of the particle fluidization. Besides, the erosion effect of particles on the gas injection tube is significant, which greatly reduces the reliability of the gas injection tube. At the same time, the gas injection may also aggravate the particle erosion for the internal heat exchange tube.

Chinese Patent Applications No. 201620189126.2 discloses a gas distribution device for an organosilicon fluidized bed reactor, of which a gas distribution plate is distributed with multiple chloromethane inlet tubes. An upper end of each chloromethane inlet tube is provided with a wind cap to avoid the blockage of the chloromethane inlet tube by particles. However, this device still cannot effectively avoid the occurrence of flow dead zones at the bottom of the reactor and local overheating caused by changes in the cross-sectional geometry of the fluidized bed reactor and the elbow of the U-shaped heat exchange tube.

Chinese Patent Publication No. 101139353A and Chinese Patent Application No, 200720176241.7 disclose a heat-uniform direct-return fluidized bed reactor for silicone monomer synthesis, which utilizes a double-cone inflow gas distributor to avoid gas bias, flow dead zones and local overheating. However, this structure is only suitable for finger-shaped heat exchange tubes, and cannot avoid the particle accumulation in the flow dead zones caused by the elbow of the U-shaped heat exchanger.

Therefore, it is necessary to develop a method to eliminate flow dead zones and local overheating caused by changes in cross-section geometry of the fluidized bed reactor, the elbow portion of the U-shaped heat exchanger and uneven gas distribution, so as to improve the selectivity of M2 (dimethyldichlorosilane).

### SUMMARY

An object of this application is to provide a method and device for preventing carbon deposition in a fluidized bed reactor for the organosilicon monomer synthesis, so as to avoid carbon deposition caused by flow dead zones and local overheating due to changes in cross-sectional geometry of the fluidized bed reactor, the elbow portion of the U-shaped heat exchanger tube and uneven gas distribution.

Technical solutions of the present disclosure are described as follows.

In a first aspect, the present disclosure provides a device for preventing carbon deposition in a fluidized bed reactor for organosilicon monomer synthesis, comprising:

a tank;

at least one U-shaped heat exchange tube arranged in the tank; and

at least one upper flow-guide block;

wherein each of the at least one U-shaped heat exchange tube comprises an elbow portion; the at least one U-shaped heat exchanger tube is arranged vertically with the elbow portion located at a lower end; the at least one upper flow-guide block is arranged on an upper surface of the elbow portion; and a width of the at least one upper flow-guide block decreases from an end connected to the elbow portion to an end away from the elbow portion.

In some embodiments, each of the at least one upper flow-guide block comprises a connection portion and a guiding portion; the connection portion is connected to the upper surface of the elbow portion; and the guiding portion is provided on a side of the connection portion away from the elbow portion.

In some embodiments, a cross section of the guiding portion is oval, triangular or arc-shaped.

In some embodiments, the connection portion is a circular arc surface concavely arranged on the elbow portion; or a cross section of the connection portion is quadrilateral, and a bottom edge of the cross section is a circular arc concavely arranged on the elbow portion.

In some embodiments, a width of the connection portion is 100-150% of a tube spacing of the at least one U-shaped heat exchange tube; and a height of the at least one upper flow-guide block is 50-200% of a height of the elbow portion.

In some embodiments, the device further comprising:

at least one lower flow-guide block;

wherein the at least one lower flow-guide block is arranged on a lower surface of the elbow portion; the at least one lower flow-guide block and the at least one upper flow-guide block are arranged in mirror symmetry with respect to a horizontal plane where a center of the elbow portion is located.

In some embodiments, a gas-solid flow active control device is provided on an outer surface of the tank, and is arranged below the elbow portion.

In some embodiments, the tank comprises an inverted cone section provided below the elbow portion; the gas-solid flow active control device has a multi-layer structure; a height of each layer of the gas-solid flow active control device is 5-20% of a height of the inverted cone section; and multiple layers of the gas-solid flow active control device are uniformly distributed on the inverted cone section.

In some embodiments, the device further comprising;

a gas inlet distributor;

wherein the gas inlet distributor is arranged below the elbow portion; and the gas inlet distributor is V-shaped, and is connected to an inner side wall of the tank; and the gas inlet distributor is provided with a plurality of gas distribution holes.

In a second aspect, this application provides a method for preventing carbon deposition in a fluidized bed reactor for organosilicon monomer synthesis by using the aforementioned device, comprising:

placing the fluidized bed reactor in the tank of the device; feeding chloromethane gas to the fluidized bed reactor through a gas inlet distributor to undergo reactions with solid silica particles in the presence of a catalyst; and

dissipating heat generated from the reactions through the at least one U-shaped heat exchange tube;

wherein the at least one upper flow-guide block is configured to alleviate particle accumulation at the elbow portion.

Compared to the prior art, the present disclosure has the following beneficial effects.

Regarding the device provided herein for preventing carbon deposition in a fluidized bed reactor for the organosilicon monomer synthesis, an upper flow-guide block is arranged on the elbow portion of the U-shaped heat exchange tube to avoid the flow dead zone and particle accumulation at the elbow portion, thereby avoiding the local overheating. Further, the lower surface of the elbow portion is provided with a lower flow-guide block, which forms an arc-shaped flow-guide surface with the upper flow-guide block, so as to further avoid the flow dead zone and particle accumulation at the elbow portion and avoid the local overheating. Further, a gas-solid flow active control device is provided to enable the active and passive regulation of the gas-solid flow in the fluidized bed reactor in combination with the upper flow-guide block having the passive flow-guide function. By means of such arrangements, the flow dead zones and local overheating, caused by change in cross-sectional geometry of the fluidized bed reactor, the elbow portion of the U-shaped heat exchange tube and uneven gas distribution, are eliminated thoroughly. According to the characteristics of the gas-solid flow in the fluidized bed reactor, a gas distributor is provided where the flow dead zone occurs, so as to further avoid particle accumulation, especially near the reactor walls. Thus, by using the device and method provided herein, the flow dead zone and local overheating caused by the change in cross-sectional geometry of the fluidized bed reactor, the elbow portion of the U-shaped heat exchange tube and uneven gas distribution, can be completely eliminated, thus improving the selectivity and yield of M2 (dimethyldichlorosilane).

### BRIEF DESCRIPTION OF THE DRAWINGS

The accompanying drawings needed in the description of embodiments of the disclosure will be briefly described below.

FIG. 1 is a schematic diagram of a device for preventing carbon deposition in a fluidized bed reactor for the organosilicon monomer synthesis according to an embodiment of the present disclosure;

FIG. 2 is a schematic diagram of a multi-layer gas-solid flow active control device provided on an inverted cone section according to an embodiment of the present disclosure;

FIG. 3 is a schematic diagram of an upper flow-guide block and a lower flow-guide block provided on a U-shaped heat exchange tube according to an embodiment of the present disclosure; and

FIG. 4 is a sectional view of FIG. 3 along A-A line.

### DETAILED DESCRIPTION OF EMBODIMENTS

The technical solutions of the present application will be clearly and completely described below with reference to the accompanying drawings and embodiments. Obviously, described below are merely some embodiments of the present application, which are not intended to limit the present application. Based on the embodiments in this application, all other embodiments obtained by a person skilled in the art without paying for creative work shall fall within the scope of this application.

As used herein, orientation or positional relationships indicated by the terms, such as “center”, “longitudinal”, “transverse”, “length”, “width”, “thickness”, “upper”, “lower”, “front”, “back”, “left”, “right”, “vertical”, “horizontal”, “top”, “bottom”, “inside”, “outside”, “clockwise” and “counterclockwise”, are based on those shown in the accompanying drawings, and are merely intended to facilitate and simplify the description of this application, other than indicating or implying that the device or element referred to must have a particular orientation and be constructed and operated in a particular orientation, and thus should not be construed as a limitation of the present application. Furthermore, the terms “first” and “second” are merely descriptive, and are not to be understood as indicating or implying relative importance or as implicitly specifying the number of technical features indicated. Thus, the features limited by “first” and “second” may explicitly or implicitly include one or more of the described features. In the description of this application, “a plurality of” means two or more, unless otherwise expressly and specifically limited.

As used herein, terms “installation”, “connection” and “linkage” should be understood in a broad sense, for example, it can be fixed connection, removable connection, or integral connection; it can be mechanical connection, or electrical connection or communication with each other; it can be direct connection, or an indirect connection through an intermediate medium; it can be a connection within two components or an interaction between two components. To a person of ordinary skill in the art, the specific meaning of the above terms in this application can be understood on a case-by-case basis.

Specifically, referring to FIGS. 1-4, this application provides a device 10 for preventing carbon deposition in a fluidized bed reactor for organosilicon monomer synthesis. The device 10 includes a tank, at least one U-shaped heat exchange tube 2, and at least one upper flow-guide block 4. The tank, as a reactor, consists of a first cylinder section 1, a second cylinder section 3 and an inverted cone section 6 from top to bottom, where the diameter of the first cylinder section 1 is largest among the three sections, and the second cylinder section 3 is a reaction zone. The U-shaped heat exchange tube 2 is provided in the tank. The U-shaped heat exchange tube 2 includes an elbow portion, which is curved in a U shape. The U-shaped heat exchange tube 2 is arranged vertically with the elbow portion located at a lower end. The at least one U-shaped heat exchange tube 2 and the at least one upper flow-guide block 4 are in one-to-one correspondence, and each upper flow-guide block 4 is arranged on an upper surface of the elbow portion of a corresponding U-shaped heat exchange tube 2. The width of the upper flow-guide block 4 decreases from an end connected to the elbow portion to an end away from the elbow portion.

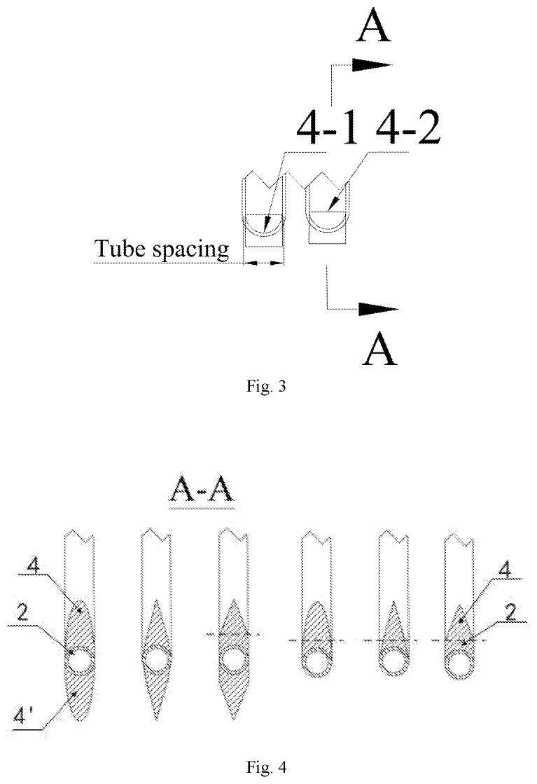

As shown in FIG. 3, the U-shaped heat exchange tubes 2 are arranged side by side.

As shown in FIG. 4, the upper flow-guide block 4 includes a connection portion 4-1 and a guiding portion 4-2. The connection portion 4-1 is connected to the upper surface of the elbow portion, and the guiding portion 4-2 is provided on the side of the connection portion 4-1 away from the elbow portion. The connection portion 4-1 of the upper flow-guide block 4 is preferably weldedly connected to the U-shaped heat exchange tube 2.

As shown in FIG. 4, the cross section of the upper flow-guide block 4 is oval, triangular or arc-shaped. The connection portion 4-1 is a circular arc surface concavely arranged on the elbow portion. In an embodiment, the cross section of the connection portion 4-1 is quadrilateral, and the bottom edge of the cross section is a circular arc concavely arranged on the elbow portion.

Further, the width of the connection portion 4-1 is 100-150% of the tube spacing of the U-shaped heat exchange tube 2, and the thickness of the connection portion 4-1 is 100-150% of the diameter of the U-shaped heat exchange tube 2. The height of the upper flow-guide block 4 is 50-200% of the height of the elbow portion.

As shown in FIG. 4, the device 10 further includes a lower flow-guide block 4′. The lower flow-guide block 4′ is arranged on the lower surface of the elbow portion. The lower flow-guide block 4′ and the upper flow-guide block 4 are arranged in mirror symmetry with respect to a horizontal plane where a center of the elbow portion is located.

Further, a gas-solid flow active control device 5 is provided on an outer surface of the tank, and is arranged below the elbow portion. According to the characteristic that the gas-solid flow has a dead zone at the bottom of the reactor, the gas-solid flow active control device 5 is provided in the corresponding area at the bottom of the tank to enhance the gas-solid circulation flow and thus avoid particle aggregation by introducing airflow in different directions and with different flow rates.

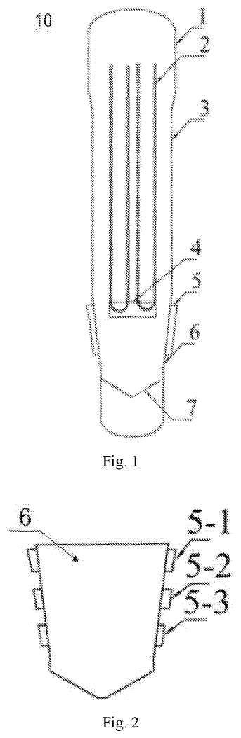

Further, the inverted cone section 6 is provided below the elbow portion. The gas-solid flow active control device 5 has a multi-layer structure, preferably 1-5 layers. In FIG. 2, three layers of the gas-solid flow active control device 5 are respectively indicated by 5-1, 5-2 and 5-3, where the height of each layer is 5-20% of the height of the inverted cone section 6, and the three layers of the gas-solid flow active control device 5 are evenly distributed on the inverted cone 6.

Further, the device 10 further includes a gas inlet distributor 7. The gas inlet distributor 7 is arranged below the elbow portion. The gas inlet distributor 7 is V-shaped, and is connected to an inner side wall of the tank. The gas inlet distributor 7 is provided with a plurality of gas distribution holes.

In summary, the first cylinder section 1, the U-shaped heat exchange tube 2, the second cylinder section 3, the inverted cone section 6, and the gas inlet distributor 7 form the main body of the fluidized bed reactor, and are connected in sequence.

The present application also provides a method for preventing carbon deposition in a fluidized bed reactor for organosilicon monomer synthesis by using the aforementioned device, which includes the following steps.

The fluidized bed reactor is placed in the tank of the device. Chloromethane gas is fed to the fluidized bed reactor through a gas inlet distributor 7 to undergo solid silica particles in the presence of a catalyst. The reaction heat is brought out by a U-shaped heat exchange tube 2. Moreover, an upper flow-guide block is provided on the elbow portion of the U-shaped heat exchange tube 2 to alleviate particle aggregation. Further, according to the characteristic that the gas-solid flow has a dead zone at the bottom of the reactor, the gas-solid flow active control device 5 is provided at the bottom of the reactor to enhance the gas-solid circulation flow and thus avoid particle aggregation by introducing airflow in different directions and with different flow rates.

In the prior art, the particle flow-guide block and the gas injection tube are not effective on eliminating flow dead zones and local overheating phenomena, and may lead to new flow dead zones and causes abrasion. For the inlet air cap and the double-cone gas distributor, they can lead to a more uniform gas-solid distribution in the finger-shaped heat exchange tube, but do not have a significant effect on the suppression of particle flow dead zones in the U-shaped heat exchange tube.

Compared to the prior art, the method and device provided herein provide two ways for suppressing the dead zone of particle flow in fluidized bed reactor. Firstly, an upper flow-guide block 4 and/or a lower flow-guide block 4′ having the flow-guide function are provided at the elbow portion of the U-shaped heat exchange tube to avoid local overheating and carbon deposition due to particle aggregation. Secondly, according to the characteristics of the gas-solid flow in the fluidized bed reactor, a gas distributor is provided where the flow dead zone occurs, so as to further avoid particle accumulation, especially near the reactor walls. Thus, by using the device and method provided herein, the flow dead zone and local overheating caused by the change in cross-sectional geometry of the fluidized bed reactor, the elbow portion of the U-shaped heat exchange tube 2 and uneven gas distribution, can be completely eliminated, thus improving the selectivity and yield of M2 (dimethyldichlorosilane).

The main features of the present disclosure are described below. In this application, the gas-solid flow in the fluidized bed reactor is regulated through both active and passive methods, completely eliminating the occurrence of flow dead zones and local overheating due to changes in cross-sectional geometry of the fluidized bed reactor, the elbow portion of the U-shaped heat exchange tube and uneven gas distribution. Compared with the conventional technologies, the device and method provided herein effectively control the gas-solid flow dead zone and reduce the local overheating while reducing the scouring and abrasion of high-speed particles at the bottom of the fluidized bed reactor on the heat exchange tube. Therefore, the method and device provided herein can significantly improve the selectivity of M2, increase the reactor capacity, and improve the generation cycle and service life of the reactor.

The beneficial effects of the present application are described below. Regarding the device provided herein for preventing carbon deposition in a fluidized bed reactor for the organosilicon monomer synthesis, an upper flow-guide block is arranged on the elbow portion of the U-shaped heat exchange tube to avoid the flow dead zone and particle accumulation at the elbow portion, thereby avoiding the local overheating. Further, the lower surface of the elbow portion is provided with a lower flow-guide block, which forms an arc-shaped flow-guide surface with the upper flow-guide block, so as to further avoid the flow dead zone and particle accumulation at the elbow portion and avoid the local overheating. Further, a gas-solid flow active control device is provided to enable the active and passive regulation of the gas-solid flow in the fluidized bed reactor in combination with the upper flow-guide block having the passive flow-guide function. By means of such arrangements, the flow dead zones and local overheating, caused by change in cross-sectional geometry of the fluidized bed reactor, the elbow portion of the U-shaped heat exchange tube and uneven gas distribution, are eliminated thoroughly. According to the characteristics of the gas-solid flow in the fluidized bed reactor, a gas distributor is provided where the flow dead zone occurs, so as to further avoid particle accumulation, especially near the reactor walls. Thus, by using the device and method provided herein, the flow dead zone and local overheating caused by the change in cross-sectional geometry of the fluidized bed reactor, the elbow portion of the U-shaped heat exchange tube and uneven gas distribution, can be completely eliminated, thus improving the selectivity and yield of M2 (dimethyldichlorosilane).

In the above embodiments, each has emphasis particularly on, and the parts that are not detailed in a particular embodiment can be found in the relevant descriptions of other embodiments.

Described above are merely illustrative to help understand the technical solutions of this application, and are not intended to limit this application. Though this application has been described in detail above with reference to the embodiments, those skilled in the art can still make various changes, modifications and replacements thereto. It should be understood that those changes, modifications and replacements made without departing from the spirit and scope of this application should still fall within the scope of this application defined by the appended claims.

What is claimed is:

1. A device for preventing carbon deposition in a fluidized bed reactor for organosilicon monomer synthesis, comprising:
a tank;
at least one U-shaped heat exchange tube arranged in the tank; and
at least one upper flow-guide block;
wherein each of the at least one U-shaped heat exchange tube comprises an elbow portion; the at least one U-shaped heat exchanger tube is arranged vertically with the elbow portion located at a lower end; the at least one upper flow-guide block is arranged on an upper surface of the elbow portion; and a width of the at least one upper flow-guide block decreases from an end connected to the elbow portion to an end away from the elbow portion.

2. The device of claim 1, wherein each of the at least one upper flow-guide block comprises a connection portion and a guiding portion; the connection portion is connected to the upper surface of the elbow portion; and the guiding portion is provided on a side of the connection portion away from the elbow portion.

3. The device of claim 2, wherein a cross section of the guiding portion is oval, triangular or arc-shaped.

4. The device of claim 3, wherein the connection portion is a circular arc surface concavely arranged on the elbow portion; or a cross section of the connection portion is quadrilateral, and a bottom edge of the cross section is a circular arc concavely arranged on the elbow portion.

5. The device of claim 2, wherein a width of the connection portion is 100-150% of a tube spacing of the at least one U-shaped heat exchange tube; and a height of the at least one upper flow-guide block is 50-200% of a height of the elbow portion.

6. The device of claim 1, further comprising:
at least one lower flow-guide block;
wherein the at least one lower flow-guide block is arranged on a lower surface of the elbow portion; and the at least one lower flow-guide block and the at least one upper flow-guide block are arranged in mirror symmetry with respect to a horizontal plane where a center of the elbow portion is located.

7. The device of claim 1, wherein a gas-solid flow active control device is provided on an outer surface of the tank, and is arranged below the elbow portion.

8. The device of claim 7, wherein the tank comprises an inverted cone section provided below the elbow portion; the gas-solid flow active control device has a multi-layer structure; a height of each layer of the gas-solid flow active control device is 5-20% of a height of the inverted cone section; and multiple layers of the gas-solid flow active control device are uniformly distributed on the inverted cone section.

9. The device of claim 1, further comprising:
a gas inlet distributor;
wherein the gas inlet distributor is arranged below the elbow portion; the gas inlet distributor is V-shaped, and is connected to an inner side wall of the tank; and the gas inlet distributor is provided with a plurality of gas distribution holes.

10. A method for preventing carbon deposition in a fluidized bed reactor for organosilicon monomer synthesis by using the device of claim 1, comprising:
placing the fluidized bed reactor in the tank of the device; feeding chloromethane gas to the fluidized bed reactor through a gas inlet distributor to undergo reactions with solid silica particles in the presence of a catalyst; and
dissipating heat generated from the reactions through the at least one U-shaped heat exchange tube;
wherein the at least one upper flow-guide block is configured to alleviate particle accumulation at the elbow portion.
